(19) United States
(12) Patent Application Publication
(10) Pub. No.: US 2014/0327517 A1
(43) Pub. Date: Nov. 6, 2014

(54) REMOTE CONTROL SYSTEM, AND METHOD FOR AUTOMATICALLY LOCKING AND/OR UNLOCKING AT LEAST ONE MOVABLE PANEL OF A MOTOR VEHICLE AND/OR FOR STARTING A MOTOR VEHICLE ENGINE USING A REMOTE CONTROL SYSTEM

(71) Applicant: Johnson Controls Automotive Electronics SAS, Stuggart (DE)

(72) Inventor: Vincent Portet, Jouy-le-moutier France (FR)

(21) Appl. No.: 14/351,112

(22) PCT Filed: Oct. 11, 2012
(86) PCT No.: PCT/EP2012/070216

§ 371 Date: Apr. 10, 2014

(30) Foreign Application Priority Data
Oct. 11, 2011 (DE) 10 2011 115 689.9
Dec. 23, 2011 (FR) 1104046

(51) Int. Cl. G07C 9/00

(52) U.S. Cl. CPC G07C 9/00007
USPC 340/5.61

(57) ABSTRACT

A remote control system and method are disclosed for automatically locking and/or unlocking at least one movable panel of a motor vehicle and/or for starting a motor vehicle engine. The remote control system includes a vehicle module to be installed inside the vehicle and a portable module to be carried by a user. The remote control system is capable of determining the distance between the vehicle module and the portable module via a first radiofrequency signal emitted by an antenna combined with the vehicle module, and a second radiofrequency signal emitted by an antenna combined with the portable module, the first radiofrequency signal being a signal obtained by phase or frequency modulation. The second radiofrequency signal is obtained by a phase-locked loop in the portable module that uses the first radiofrequency signal as a reference for generating the second radiofrequency signal.

### BACKGROUND

The present invention relates to a remote control system, in particular for automatically locking and/or unlocking at least one movable panel of an automotive vehicle and/or for starting an engine of an automotive vehicle.

Moreover, the present invention relates to a method for automatically locking and/or unlocking at least one movable panel of an automotive vehicle and/or for starting an engine of an automotive vehicle with the aid of a remote control system.

Access control systems and methods are known which comprise a portable module, such as a customized portable object, for opening and/or starting an automotive vehicle, and which operate by wireless transmission of a coded identification signal.

Accordingly, electronic means are provided in the automotive vehicle. These electronic means comprise, in particular, access management means linked to signals reception means and/or emission means. The method of automotive vehicle access control consists in transmitting one or more coded signals between a vehicle module in the automotive vehicle and the portable module. A verification of the coded signal is effected in access management means.

The portable module may in particular be an electronic key, a watch, a portable telephone, a chip card, a badge or some other portable device. Preferably, this portable object is an electronic key for vehicle access control. This portable object may in particular comprise its own energy source for powering the electronic components thereof.

To facilitate access to the vehicle without having to manipulate the electronic key comprising the portable module, there has already been proposed an electronic key from which a response signal is automatically transmitted to the vehicle as a function of an interrogation signal received from the vehicle module in the automotive vehicle. Accordingly, the portable module must be situated in a restricted zone around the vehicle in order to receive this interrogation signal originating from the vehicle module in the automotive vehicle.

With the use of such a system, there is the risk of allowing the opening of the vehicle by way of intermediate relays without the knowledge of the carrier of the portable module. Therefore, this affords ill-intentioned persons the possibility of using these intermediate relays between the vehicle and the carrier of the electronic key to open the vehicle and turn it on. Said relays are able to reproduce, destined for the portable module, respectively for the vehicle module, the interrogation signal, respectively the response signal which each comprise in particular a sequence of binary data. Such an attack is also called attack by intermediate relays.

### SUMMARY

The aim of the present invention is in particular to alleviate the drawbacks of the known art, and in particular those cited hereinabove, and its aim is also to propose a remote control system, in particular for automatically locking and/or unlocking at least one movable panel of an automotive vehicle and/or for starting an engine of an automotive vehicle which is at one and the same time capable of dependably detecting attacks, in particular by intermediate relay, and which can be implemented with reduced costs.

According to the present invention, this aim is achieved, by a remote control system, in particular for automatically locking and/or unlocking at least one movable panel of an automotive vehicle and/or for starting an engine of an automotive vehicle, the remote control system comprising a vehicle module intended to be installed inside the vehicle, the remote control system moreover comprising a portable module intended to be carried by a user of the remote control system, the remote control system being able to determine the distance between the vehicle module, on the one hand, and the portable module, on the other hand, by way, on the one hand, of a first radiofrequency signal emitted by an antenna associated with the vehicle module, and, on the other hand, of a second radiofrequency signal emitted by an antenna associated with the portable module, the first radiofrequency signal being a signal obtained by a phase modulation or by a frequency modulation, and the second radiofrequency signal being a signal obtained by employing a phase-locked loop in the portable module, the phase-locked loop taking the first radiofrequency signal as reference to generate the second radiofrequency signal.

On account of such an implementation of the monitoring system, it is advantageously possible according to the present invention to prevent possible intermediate relays held by ill-intentioned persons from serving as a bridge between the vehicle module and the portable module.

It is preferred according to the present invention that the portable module comprises a radiofrequency identification transponder (RFID-transponder).

According to the present invention, it is advantageously possible to determine the distance between the vehicle, that is to say between the vehicle module, and the portable module, that is to say for example the key of the car. The determination of the distance is in particular carried out by monitoring a phase modulation or a frequency modulation of signals which are exchanged between the vehicle module and the portable module.

Thus attacks by intermediate relays can be reliably avoided. It is preferred according to the present invention that the first radiofrequency signal, emitted by an antenna associated with the vehicle module, is an additional signal with respect to the interrogation signal which is also emitted by the vehicle module. This is why, hereinafter, the interrogation signal is also called third radiofrequency signal.

Preferably, the third radiofrequency signal is provided for the authentication of the portable module with respect to the vehicle module.

It is thus advantageously possible according to the present invention that the vehicle module emits the third radiofrequency signal and the first radiofrequency signal, and that by the second radiofrequency signal, the portable module responds not only to the third radiofrequency signal (that is to say the interrogation signal which is known in the prior art), but also to the first radiofrequency signal which comprises a phase modulation and/or a frequency modulation (or which is obtained by a phase modulation and/or by a frequency modulation).

Yet another preferred enhancement of the invention resides in the fact that remote control system is a hands-free access system.

On account of such an implementation of a remote control system, it is advantageously possible to render the use of the system more comfortable to a user of the automotive vehicle.

A particularly preferred enhancement of the invention resides in the fact that the vehicle module is configured in such a way as to emit in a cyclic manner the first radiofrequency signal and/or the third radiofrequency signal so as to detect the presence of the portable module.

On account of such an implementation of the remote control system, it is advantageously possible according to the present invention to detect the presence of the portable module in a fast and effective manner so as to render the use of the system comfortable for use on a daily basis.

Yet another preferred enhancement of the invention resides in the fact that the first radiofrequency signal and/or the second radiofrequency signal is a radiofrequency signal or are radiofrequency signals having a high frequency lying between 5 and 500 MHz, in particular between 6.765 MHz and 6.795 MHz or between 13.553 MHz and 13.567 MHz or between 26.957 MHz and 27.283 MHz or between 40.66 MHz and 40.70 MHz or between 433.05 MHz and 434.79 MHz or between 868 MHz and 870 MHz.

On account of such an implementation of the remote control system, it is advantageously possible according to the present invention to use the ISM frequencies (also called ISM bands, the abbreviation standing for “industrial scientific, and medical” for industrial, scientific, medical, domestic or similar applications) or else authorized frequencies. These frequency bands are generally shared with frequency bands harmonized for radio communication equipment.

According to the present invention, in particular the first radiofrequency signal is emitted using a frequency in the ISM band.

With the aid of the first radiofrequency signal, it is in particular possible, according to the present invention, to transmit additional functions between the vehicle module and the portable module. Thus, it is for example possible, to transmit an optical formation, an optical item of information and/or an acoustic item of information which takes place, for example, after operating a button of the key of the vehicle (carrying out or triggering a function in the portable module).

A particularly preferred enhancement of the invention resides in the fact that the first radiofrequency signal and the second radiofrequency signal are radiofrequency signals having different frequencies, such that either the frequency of the first radiofrequency signal is the result of a multiplication of the frequency of the second radiofrequency signal by an integer or by a fraction, or the frequency of the second radiofrequency signal is the result of a multiplication of the frequency of the first radiofrequency signal by an integer or by a fraction.

On account of such an implementation of the remote control system, it is advantageously possible according to the present invention to use a system for multiplying frequencies between the reception of the first radiofrequency signal and the transmission of the second radiofrequency signal (or a system for frequency division between the reception of the first radiofrequency signal and the transmission of the second radiofrequency signal), and a process for dividing frequencies between the reception of the second radiofrequency signal and the comparison between the origin of the first radiofrequency signal and the signal received as second radiofrequency signal (or a process for multiplying frequencies between the reception of the second radiofrequency signal and the comparison between the signal received as second radiofrequency signal and the origin of the first radiofrequency signal).

Yet another preferred enhancement of the invention resides in the fact that the third radiofrequency signal is a low-frequency signal having a frequency lying between 20 and 500 kHz.

On account of such an implementation of the remote control system, it is advantageously possible according to the present invention to use as third radiofrequency signal a signal generally used as interrogation signal, in particular a signal for example of 125 kHz.

Moreover, the present invention also relates to a method for automatically locking and/or unlocking at least one movable panel of an automotive vehicle and/or for starting an engine of an automotive vehicle with the aid of a remote control system, the remote control system comprising a vehicle module intended to be installed inside the vehicle, the remote control system moreover comprising a portable module intended to be carried by a user of the remote control system, the remote control system being able to determine the distance between the vehicle module, on the one hand, and the portable module, on the other hand, by way, on the one hand, of a first radiofrequency signal emitted by an antenna associated with the vehicle module, and, on the other hand, of a second radiofrequency signal emitted by an antenna associated with the portable module, the method comprising the following steps:
during a first step of the method, the first radiofrequency signal is generated by way of a phase modulation or of a frequency modulation of an initial signal,
during a second step of the method, the first radiofrequency signal is emitted by the vehicle module toward the portable module,
during a third step of the method, the second radiofrequency signal is generated by way of a phase-locked loop in the portable module, the phase-locked loop taking the first radiofrequency signal as reference to generate the second radiofrequency signal,
during a fourth step of the method, the second radiofrequency signal is emitted by the portable module toward the vehicle module.

On account of such an implementation of the method, it is advantageously possible according to the present invention to increase the level of security of the communication between the vehicle module and the portable module.

A particularly preferred enhancement of the invention resides in the fact that during a fifth step of the method, the second radiofrequency signal, after reception by the vehicle module, is compared with the first radiofrequency signal.

Other characteristics and advantages of the invention will emerge from reading the description which follows of a nonlimiting particular embodiment of the present invention.

### DRAWINGS

The invention will be better understood by virtue of the description hereinafter, which pertains to preferred embodiments, given by way of nonlimiting example and explained with references to the appended schematic drawing, in which:

FIG. 1 is a schematic view of the communication between a vehicle and a key of the automotive vehicle, the vehicle comprising the vehicle module and the key of the vehicle comprising the portable module, and

FIG. 2 is a schematic view of the communication between the vehicle module and the portable module as regards the first and the second radiofrequency signal.

### DETAILED DESCRIPTION

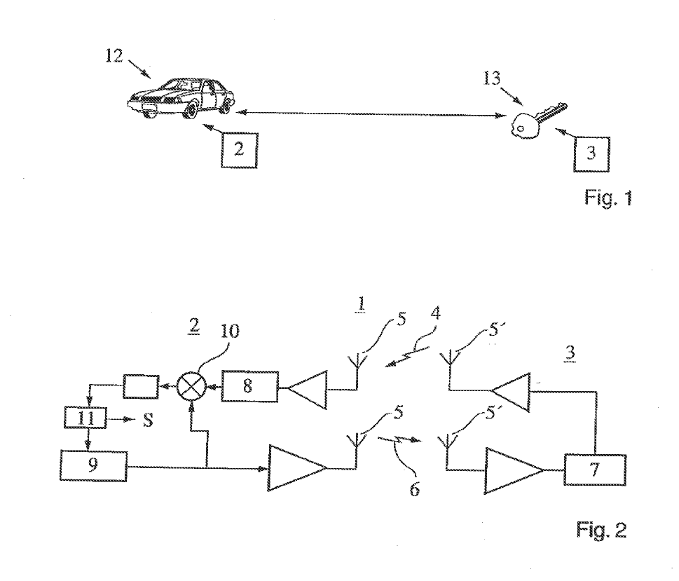

FIG. 1 schematically shows a remote control system, in particular for automatically locking and/or unlocking at least one movable panel of an automotive vehicle 12 and/or for starting an engine of an automotive vehicle 12. The remote control system 1 comprises a vehicle module 2 which is situated in the automotive vehicle 12 and, moreover a portable module 3 which is situated in particular in a car key 13 or else in a badge element 13 intended to be carried by a user of the automotive vehicle.

According to the present invention, the remote control system 1 is able to determine the distance (or at least to determine whether the distance exceeds a predetermined distance threshold) between the vehicle module 2, on the one hand, and the portable module 3, on the other hand, by way, on the one hand, of a first radiofrequency signal 6 emitted by an antenna associated with the vehicle module 2, and, on the other hand, of a second radiofrequency signal 4 emitted by an antenna associated with the portable module 3.

Accordingly, the vehicle module 2 and also the portable module 3 comprise control management means for generating radiofrequency signals, and also for receiving radiofrequency signals and also for analyzing radiofrequency signals. The expression movable panel is naturally understood to mean the hinged or sliding side doors and also the trunk or the tailgate of the vehicle.

A remote control system 1 of hands-free type (keyless entry system, or keyless go system) generally operates in the following manner:

The presence of the portable module in a predefined perimeter around the automotive vehicle 12 is detected. The detection of the portable module will awaken, in a management module in the automotive vehicle 12, in particular the vehicle module 2, an access computer which undertakes by radio communication the authentication of the portable module 3 so as to verify that the portable module 3 is indeed associated with the automotive vehicle 12. In the case of negative authentication, the search for the presence of a portable module 3 inside the determined perimeter is continued. In the case of positive authentication, the remote opening system is placed in a state ready to be unlocked, in particular for all the movable panels. This means that after emission, by the vehicle module 2, of the interrogation signal (or third radiofrequency signal), the vehicle module 2 waits for reception of the correct response signal to open the movable panels of the automotive vehicle 12. The interrogation signal and also the response signal are coded signals, and the vehicle module 2 can determine (upon a positive authentication) that the two codes whose signals correspond to one another.

According to the present invention, with the aid of the first radiofrequency signal which is an additional signal with respect to the interrogation signal known in the prior art, it is advantageously possible to determine the distance (or at least to discern whether the distance exceeds a certain threshold) between the vehicle module and the portable module so as to prevent attacks by intermediate relay.

For this purpose, the vehicle module 2 emits the first radiofrequency signal 6 which is received by the portable module 3. Moreover, the portable module 3 emits the second radiofrequency signal 4 which is received by the vehicle module 2. According to the present invention, the second radiofrequency signal 4 can correspond to the response signal that the portable module transmits in response to the interrogation signal (third radiofrequency signal) or it can correspond to an additional radiofrequency signal (that is to say the third radiofrequency interrogation signal corresponds to a radiofrequency response signal which is different from the second radiofrequency signal, and the first and second radiofrequency signals are additional signals).

FIG. 2 shows the exchange between the first radiofrequency signal 6 and the second radiofrequency signal between the vehicle module 2 and the portable module 3.

It is preferred according to the present invention that the first radiofrequency signal 6 is a signal in the ISM band while the second radiofrequency signal is a signal in the UHF (ultra high frequency) band.

In a preferred embodiment according to the present invention, a radiofrequency signal obtained by a phase modulation and/or by a frequency modulation is generated with the aid of an oscillator 9 in the vehicle module 2 and transmitted by way of an antenna 5 of the vehicle module 2 toward the portable module 3. The portable module 3, by way of an antenna 5′ receives the signal transmitted by the vehicle module 2 as first radiofrequency signal 6. By way of a phase-locked loop 7 in the portable module 3, the signal received by the portable module 3 as first radiofrequency signal 6 is modified to obtain the second radiofrequency signal 4. Notably, a multiplication of frequencies is carried out in the portable module 3 to obtain a different frequency for the second radiofrequency signal 4 with respect to the first radiofrequency signal 6. Alternatively, a frequency division can be carried out or provided for in the portable module 3. By way of the antenna 5 of the portable module 3, the radiofrequency signal is re-emitted by the portable module 3 as second radiofrequency signal 4 toward the vehicle module 2. By way of the antenna 5′ of the vehicle module 2, the second radiofrequency signal 4 is received and processed in an inverse manner to the processing in the portable module 3. For example, a division unit 8 carries out a division of frequencies when, in the portable module 3, a multiplication of frequencies has been carried out. Thereafter, the signal resulting from the processing of the second radiofrequency signal 4 received by a vehicle module 2, and also the original signal of the first radiofrequency signal 6 at the output of the oscillator (or of the generator) 9 in the vehicle module 3 are mixed in a mixer circuit 10. At the output of the mixer 10 there may be a low-pass filter which allows the low frequencies to pass through, the result of which is provided to a microprocessor 11 which can determine the shift of phases and/or the difference of the phase modulation between the first signal 6 emitted from the vehicle module 2 toward the portable module 3, on the one hand, and the second radiofrequency signal 4 between the portable module 3 and the vehicle module 2, on the other hand.

When the phase shift and/or the difference in modulation between the first and the second radiofrequency signal 6, 4 are too significant, it is assumed that the distance between the automotive vehicle 2 and the key 13, that is to say the portable module 3, is too large, and an attack by intermediate relay cannot be excluded thereby resulting in a signal S as a function of which the automotive vehicle 2, and most particularly a movable panel of the automotive vehicle is not automatically unlocked.

According to the present invention, it is also advantageously possible to carry out unlocking more quickly when a user of the automotive vehicle moves away from the vehicle 2.

1. A remote control system, in particular for automatically locking and/or unlocking at least one movable panel of an automotive vehicle and/or for starting an engine of an automotive vehicle, comprising:
a vehicle module configured to be installed inside the vehicle, and
a portable module configured to be carried by a user of the remote control system,
the remote control system being configured to determine a distance between the vehicle module and the portable module via a first radiofrequency signal emitted by an antenna associated with the vehicle module and a second radiofrequency signal emitted by an antenna associated with the portable module,
the first radiofrequency signal being a signal obtained by a phase modulation or by a frequency modulation, and
the second radiofrequency signal being a signal obtained by employing a phase-locked loop in the portable module, the phase-locked loop taking the first radiofrequency signal as reference to generate the second radiofrequency signal.

2. The remote control system as claimed in claim 1, wherein a third radiofrequency signal is provided for the authentication of the portable module with respect to the vehicle module.

3. The remote control system as claimed claim 1 wherein the remote control system comprises a hands-free access system.

4. The remote control system as claimed in claim 1, wherein the vehicle module is configured to emit in a cyclic manner the first radiofrequency signal and/or a third radiofrequency signal to detect the presence of the portable module.

5. The remote control system as claimed in claim 1, wherein the first radiofrequency signal and/or the second radiofrequency signal is a radiofrequency signal or are radiofrequency signals having a high frequency lying between 5 and 500 MHz.

6. The remote control system as claimed in claim 1, wherein the first radiofrequency signal and the second radiofrequency signal have different frequencies.

7. The remote control system as claimed in claim 2, wherein the third radiofrequency signal is a low-frequency signal having a frequency lying between 20 kHz and 500 kHz.

8. The remote control system as claimed in claim 1, wherein the portable module comprises a rechargeable battery.

9. A method for automatically locking and/or unlocking at least one movable panel of an automotive vehicle and/or for starting an engine of an automotive vehicle with the aid of a remote control system, the remote control system comprising a vehicle module configured to be installed inside the vehicle, and a portable module configured to be carried by a user of the remote control system, the remote control system being configured to determine the distance between a vehicle module and the portable module via a first radiofrequency signal emitted by an antenna associated with the vehicle module (2), and a second radiofrequency signal emitted by an antenna associated with the portable module, the method comprising:
generating a first radiofrequency signal by phase modulation or frequency modulation of an initial signal,
emitting the first radiofrequency signal by the vehicle module toward the portable module,
generating a second radiofrequency signal by a phase-locked loop in the portable module, the phase-locked loop taking the first radiofrequency signal as reference to generate the second radiofrequency signal,
emitting the second radiofrequency signal by the portable module toward the vehicle module.

10. The method as claimed in claim 9, comprising, after reception by the vehicle module, comparing the second radiofrequency signal with the first radiofrequency signal. Page 7

11. The remote control system as claimed in claim 1, wherein the first radiofrequency signal and/or the second radiofrequency signal is or are between 6.765 MHz and 6.795 MHz or between 13.553 MHz and 13.567 MHz or between 26.957 MHz and 27.283 MHz or between 40.66 MHz and 40.70 MHz or between 433.05 MHz and 434.79 MHz.

12. The remote control system as claimed in claim 6, wherein the frequency of the first radiofrequency signal is the result of a multiplication of the frequency of the second radiofrequency signal by an integer.

13. The remote control system as claimed in claim 6, wherein the frequency of the first radiofrequency signal is the result of a multiplication of the frequency of the second radiofrequency signal by a fraction.

14. The remote control system as claimed in claim 6, wherein the frequency of the second radiofrequency signal is the result of a multiplication of the frequency of the first radiofrequency signal by an integer.

15. The remote control system as claimed in claim 6, wherein the frequency of the second radiofrequency signal is the result of a multiplication of the frequency of the first radiofrequency signal by a fraction.
